(19) United States
(12) Patent Application Publication
(10) Pub. No.: US 2009/0141211 A1
(43) Pub. Date: Jun. 4, 2009

(54) Liquid crystal display device

(75) Inventors: Tsutomu Furuya, Niihama-shi (JP); Mari Toyoshima, Matsuyama-shi (JP)

Correspondence Address: FOLEY AND LARDNER LLP;SUITE 500, 3000 K STREET NW, WASHINGTON, DC, 20007, US

(73) Assignee: Sumitomo Chemical Company, Limited

(21) Appl. No.: 12/289,922

(22) Filed: Nov. 6, 2008

(30) Foreign Application Priority Data
Nov. 7, 2007 (JP) 2007-289988

(51) Int. Cl. G02F 1/1335

(52) U.S. Cl. 349/64

(57) ABSTRACT

A liquid crystal display device is provided, which includes, in this order, a light source, an optical diffusion layer, and a liquid crystal panel having polarizing plates disposed on both surfaces of a liquid crystal cell, wherein a surface of the optical diffusion layer on a liquid crystal panel side has a periodic fine shape, and an uppermost surface of the polarizing plate disposed on a visible side of the liquid crystal panel has an antiglaring layer having a random fine uneven shape and having a transmittance clearness degree of not more than 150%. While having a high brightness with less electric power as compared with the prior art, the liquid crystal display device does not generate a Moire fringe.

### BACKGROUND OF THE INVENTION

1. Field of the Invention

The present invention relates to a liquid crystal display device including, in this order, a light source, an optical diffusion layer, and a liquid crystal panel having polarizing plates disposed on both surfaces of a liquid crystal cell.

2. Description of the Related Art

A liquid crystal display device is now coming to be used for a portable television set, a lap-top personal computer, or the like owing to the characteristics such as light weight, small thickness, and low consumption power. Today, it is also coming to be used for an image viewing apparatus such as a large-scale television set. In a liquid crystal display device used for the purpose of displaying images such as a television receiving apparatus, an improvement in brightness is required for the improvement of visibility. Also, since the electric power consumed in the light source occupies a considerable part of the total electric power consumed in the liquid crystal display device as a whole, it is preferable to reduce the total electric power for giving a needed brightness in order to increase the lifetime of a battery in an apparatus of a type that supplies electric power with the battery. Further, from the viewpoint of environmental protection, it is preferable to reduce the electric power for giving a predetermined brightness.

For such an improvement in brightness, a brightness enhancement film (Brightness Enhancement Film (BEF): registered trademark of 3M Corporation, United States) is widely used which is an optical sheet on which unit prisms having a triangular cross-sectional shape such as shown in FIG. 2 are periodically arranged in one direction. This brightness enhancement film is often used by disposing an optical diffusion layer on the side opposite to the prism surface thereof. Also, in recent years, a light-diffusing optical sheet is also used which is disclosed in Japanese Patent Laying-Open No. 2006-208930 (Patent Document 1) and Japanese Patent Laying-Open No. 2006-330149 (Patent Document 2) and having a cross-sectional structure shown in FIG. 3, in which a lens sheet, an optical reflection layer having an opening at a position corresponding to the convex part of the lens sheet, an adhesive layer or a pressure sensitive adhesive layer, and an optical diffusion layer are laminated in this order. These brightness improvement sheets are often disposed between the light source and the liquid crystal panel in view of effectively utilizing the light from the light source.

However, these optical sheets intended for the purpose of effectively utilizing the light has a periodic shape on the uppermost surface thereof, thereby raising a problem of generating a Moire fringe by interference with the pattern of the liquid crystal cell. Here, for example, when a liquid crystal panel having a pattern shown in FIG. 4A and a diffusion plate having a pattern shown in FIG. 4B are superposed, a stripe-shaped region that looks bright and a stripe-shaped region that looks dark may be alternately arranged as shown in FIG. 4C. The term “Moire fringe” refers to a stripe pattern that is visually generated by a periodic shift when a plurality of regularly arranged repetition patterns such as these are superposed.

The generation of a Moire fringe can be eliminated by disposing an optical diffusion layer that randomly diffuses the direction of light between the brightness improvement sheet and the liquid crystal panel. However, when such an optical diffusion layer is provided, there may be raised a problem of decrease in brightness as a liquid crystal display device or increase in the costs.

On the other hand, the polarizing plates disposed on both surfaces of the liquid crystal cell in a liquid crystal display device are typically used in such a manner that a protective layer is disposed on one surface or on both surfaces of a polarizing film, and generally a triacetylcellulose film is used as the protective layer. Further, in a liquid crystal display device, the visibility is considerably deteriorated when external light is reflected on the image displaying surface thereof Therefore, for use in a television set and a personal computer that emphasizes the image quality and the visibility, a treatment for preventing such reflection is generally performed on the display device surface. For the reflection preventing treatment, what is known as an antiglaring treatment that diffuses incident light by forming fine unevenness on the surface to blur the reflected image can be realized at a comparatively low cost, so that it is suitably used in large personal computers, monitors, television sets, and the like.

As a film that imparts such an antiglaring property, Japanese Patent Laying-Open No. 2002-365410 (Patent Document 3) discloses an antiglaring optical film which is an optical film having fine unevenness formed on the surface thereof, where the profile of reflected light satisfies a specific relationship when a light beam is let to be incident in a direction of −10° relative to the normal line onto the surface of the film and only the light reflected from the surface is observed. Also, Japanese Patent Laying-Open No. 2002-189106 (Patent Document 4) discloses an antiglaring film in which an ionizing radiation curing resin sandwiched between an emboss mold and a transparent resin film is cured to form fine unevenness whose three-dimensional ten-point average roughness and average distance between adjacent convex parts on the three-dimensional roughness standard surface respectively assume predetermined values, and an ionizing radiation curing resin layer having the unevenness formed thereon is disposed on the above-described transparent resin film.

### SUMMARY OF THE INVENTION

The present invention has been made in order to solve the problem of the generation of a Moire fringe in a liquid crystal display device in which an optical diffusion layer including a brightness improvement sheet is disposed between a light source and a liquid crystal panel, and an object thereof is to provide a liquid crystal display device that has a high brightness with less electric power as compared with the prior art, and does not generate a Moire fringe.

The present inventors have made researches for improving the brightness and restraining the generation of a Moire fringe in a liquid crystal display device including, in this order, a light source, an optical diffusion layer, and a liquid crystal panel having polarizing plates disposed on both surfaces of a liquid crystal cell. As a result of this, the present inventors have found out that the liquid crystal display device will have a high brightness even with a small electric power and will not generate a Moire fringe when the surface of the optical diffusion layer on the liquid crystal panel side has a periodic fine shape, and an antiglaring layer having specific optical properties imparted thereto is disposed on the uppermost surface of the polarizing plate disposed on the displaying surface side of the liquid crystal cell, namely, on the visible side of the liquid crystal panel. Then, the present invention has been completed by adding various considerations to the knowledge. That is, the present invention is as follows.

The liquid crystal display device of the present invention includes, in this order, a light source, an optical diffusion layer, and a liquid crystal panel having polarizing plates disposed on both surfaces of a liquid crystal cell, and is characterized in that a surface of the optical diffusion layer on a liquid crystal panel side has a periodic fine shape, and an uppermost surface of the polarizing plate disposed on a visible side of the liquid crystal panel has an antiglaring layer having a random fine uneven shape and having a transmittance clearness degree of not more than 150%.

Preferably, the antiglaring layer in the liquid crystal display device of the present invention has a transmittance clearness degree of not more than 100%.

Preferably, the periodic fine shape on the surface of the optical diffusion layer in the liquid crystal display device of the present invention is constructed with a lens sheet in which a plurality of unit lenses are arranged on a liquid crystal panel side thereof.

Also, the above-described lens sheet is preferably a lenticular sheet having a lens part in which a plurality of semi-cylindrical convex cylindrical lenses are arranged in parallel in one direction.

According to the present invention, a liquid crystal display device is provided that has a high brightness even with less electric power as compared with the prior art, and does not generate a Moire fringe.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross-sectional view illustrating one preferable example of a liquid crystal display device 1 according to the present invention.

FIG. 2 is a schematic cross-sectional view illustrating one preferable example of an optical diffusion layer 11 that can be suitably used in the liquid crystal display device of the present invention.

FIG. 3 is a schematic cross-sectional view illustrating another preferable example of an optical diffusion layer 21 that can be suitably used in the liquid crystal display device of the present invention.

FIGS. 4A to 4C are drawings for illustrating generation of a Moire fringe.

### DESCRIPTION OF THE PREFERRED EMBODIMENTS

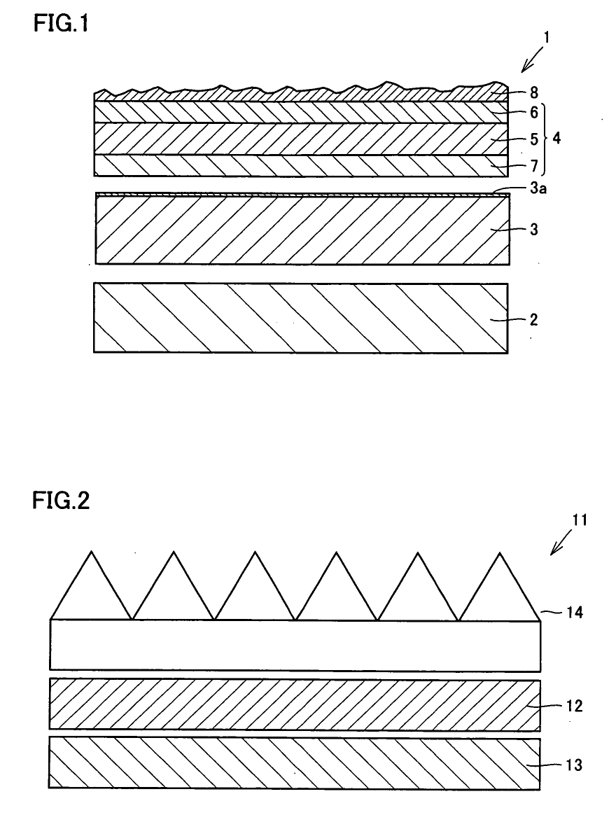

FIG. 1 is a schematic cross-sectional view illustrating one preferable example of a liquid crystal display device 1 according to the present invention. Referring to FIG. 1, liquid crystal display device 1 of the present invention is characterized in that, in a basic structure including, in this order, a light source 2, an optical diffusion layer 3, and a liquid crystal panel 4 having polarizing plates 6, 7 disposed on both surfaces of a liquid crystal cell 5, a surface 3a of optical diffusion layer 3 on a liquid crystal panel 4 side has a periodic fine shape, and an uppermost surface of polarizing plate 6 disposed on a visible side of liquid crystal panel 4 which is the displaying surface side of liquid crystal display device I has an antiglaring layer 8 having specific optical properties imparted thereto. Liquid crystal display device 1 of the present invention as described above has a high brightness even with less electric power as compared with the prior art, and does not generate a Moire fringe.

In liquid crystal display device 1 of the present invention, the periodic fine shape on surface 3a of optical diffusion layer 3 is formed for the purpose of effectively utilizing the light on the light exiting side which is the liquid crystal panel 4 side of optical diffusion layer 3. Here, the term “periodic fine shape” refers to a shape in which one or more convex (convex lens shape, columnar shape, conical shape, prismatic shape, cylindrical lens shape, or the like) or concave (convex lens shape or the like) fine unit shapes are formed to have a predetermined period. Here, the term “fine” refers to the state such that the width of the unit shape is approximately 1000 μm or below and the height thereof is approximately 1000 μm or below. Also, the term “periodic” refers to the state such that the distance (pitch) between center lines of unit shapes adjacent to each other is approximately constant within a range of from 10 to 1000 μm. The distance (pitch) between the center lines of unit shapes is more preferably from 20 to 200 μm. An optical diffusion layer whose surface 3a has such a periodic fine shape can be formed by laminating a conventionally known brightness enhancement film (Brightness Enhancement Film (BEF)) described above on an optically diffusing sheet, or by using an optical sheet in which a lens sheet, an optical reflection layer having an opening at a position corresponding to the convex part of the lens sheet, an adhesive layer or a pressure sensitive adhesive layer, and an optical diffusion layer are laminated in this order, such as those disclosed in the above-described Patent Documents 1 and 2.

Here, FIG. 2 is a schematic cross-sectional view illustrating one preferable example of an optical diffusion layer 11 that can be suitably used in the liquid crystal display device of the present invention. Optical diffusion layer 11 of the example shown in FIG. 2 is provided with a structure such that a prism sheet 14 in which unit prisms having a triangular cross-sectional shape are periodically arranged in one direction is laminated on optical diffusion sheets 12, 13. Here, prism sheet 14 is constructed with the above-described brightness enhancement film (Brightness Enhancement Film (BEF): registered trademark of 3M Corporation, United States).

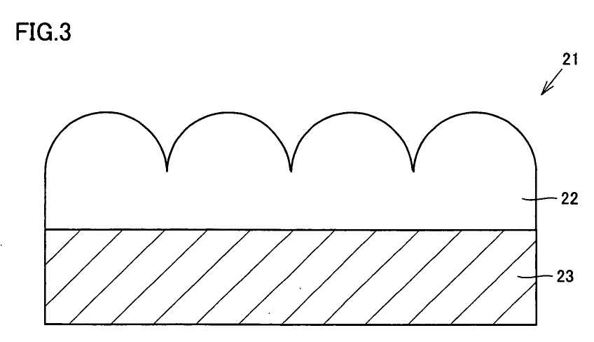

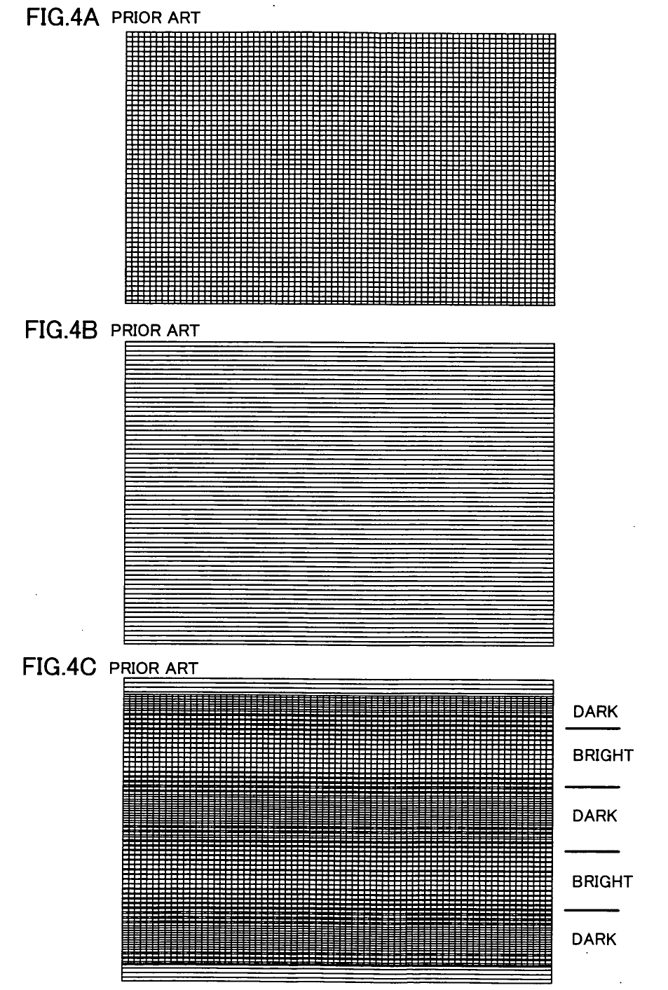

Also, FIG. 3 is a schematic cross-sectional view illustrating another preferable example of an optical diffusion layer 21 that can be suitably used in the liquid crystal display device of the present invention. Optical diffusion layer 21 of the example shown in FIG. 3 is provided with a structure in which a lens sheet 22 having a convex lens shape is laminated on a base material 23 having an optical diffusion property, disclosed in the above-described Patent Documents 1 and 2. Between lens sheet 22 and base material 23, there is provided an optical reflection layer having an opening at a position corresponding to the convex part of the convex lens, and the optical reflection layer is bonded to base material 23 via the adhesive layer or the pressure sensitive adhesive layer (illustration of these optical reflection layer and adhesive layer or pressure sensitive adhesive layer is not provided).

Among these, from the viewpoint of improving the brightness, as shown in FIG. 3, it is preferable to use an optical diffusion layer 21 provided with a structure in which a lens sheet 22 made by disposing a plurality of unit lenses is laminated on the liquid crystal panel side of base material 23. Further, from the viewpoint of facility in cutting the mold for molding and lens molding, it is especially preferably an optical diffusion layer using a lenticular sheet having a lens part in which a plurality of semi-cylindrical convex cylindrical lenses are arranged in parallel in one direction, as a lens sheet of the structure shown in FIG. 3. Such optical diffusion layers having an especially preferable structure can be fabricated according to the method disclosed in the above-described Patent Documents 1 and 2, and preferably have a structure disclosed therein.

In the present invention, polarizing plates 6, 7 are bonded on both surfaces of liquid crystal cell 5, so as to form liquid crystal panel 4. For the bonding between the liquid crystal cell and the polarizing plates, a pressure sensitive adhesive is typically used. Here, the driving mode of the liquid crystal cell may be, for example, the TN mode, the VA mode, the IPS mode, or the like; however, it is not particularly limited. Also, for light-source 2 used in liquid crystal display device 1 of the present invention, a light source that is conventionally used widely in the relevant field may be used without any particular limitation, and for example, a cold cathode ray tube, a light-emitting diode (LED), or the like can be suitably used as the light source.

Polarizing plates 6, 7 used in the present invention may be what is generally known as a polarizing film or a polarizing plate of a type that transmits linearly polarized light that oscillates in one of the directions perpendicular to each other in a film plane and absorbs linearly polarized light that oscillates in the other direction. Specifically, as the polarizing film, a film obtained by performing monoaxial stretching and dyeing with a dichroic pigment on a polyvinyl alcohol film and further performing crosslinking with boric acid can be used. Among the polarizing films, there are an iodine-series polarizing film that uses iodine as a dichroic pigment and a dye-series polarizing film that uses a dichroic dye as a dichroic pigment. In the liquid crystal display device of the present invention, either of the two may be used. Also, as polarizing plates 6, 7 in the present invention, the above-described polarizing film alone may be used; however, a polarizing plate in which a protective film formed with triacetylcellulose or the like is laminated on one surface or both surfaces of the polarizing film is typically used. For polarizing plates 6, 7, a commercially available one may be used, and SUMIKARAN SRDB31E (manufactured by Sumitomo Chemical Co., Ltd.) can be mentioned as a suitable commercially available product.

As described above, polarizing plates 6, 7 are generally bonded onto liquid crystal cell 5 with use of a pressure sensitive adhesive. Preferably, a retardation plate for enlarging the viewing angle of the liquid crystal display device is suitably disposed between the polarizing plate and the liquid crystal cell in accordance with the driving mode. At that time, a film having a function of a retardation plate may be used as the protective film on the liquid crystal cell side.

As described above, in the liquid crystal display device of the present invention, antiglaring layer 8 is disposed on the uppermost surface of polarizing plate 6 disposed on the visible side of liquid crystal panel 4 among polarizing plates 6, 7 disposed respectively on both surfaces of liquid crystal cell 5. This antiglaring layer 8 may be allowed to have a role as the protective film of polarizing plate 6. In this case, polarizing plate 6 is preferably realized to have a protective film such as described above on the side opposite to the side where antiglaring layer 8 of the polarizing film is disposed.

For antiglaring layer 8 used in the present invention, those having a surface shape in which fine uneven shapes are randomly formed and having a transmittance clearness degree of not more than 150% are used. Here, the transmittance clearness degree of antiglaring layer 8 refers to a sum of the values as measured by a mapping property measurement apparatus ICM-1DP (manufactured by Suga Test Machine Co., Ltd.) using four kinds of optical combs in which the width between dark parts and bright parts is 0.125 mm, 0.5 mm, 1.0 mm, and 2.0 mm according to the provisions of JIS K 7105. The maximum value of the transmittance clearness degree according to this definition will be 400%. When an antiglaring layer in which this transmittance clearness degree exceeds 150% is used, it is impossible to eliminate the Moire fringe that is generated by interference between the periodic fine surface shape of the optical diffusion layer for effectively utilizing the light of the exiting surface and the liquid crystal cell pattern. Here, the intensity (strong or weak) of the Moire fringe that is generated by the above-described interference between the periodic fine surface shape on the surface of the optical diffusion layer on the liquid crystal panel side and the cell pattern of liquid crystal cell 5 changes depending on the pitch of the periodic fine shape and the cell pattern, the gap between the periodic fine shape and the liquid crystal cell, and the like. In order to eliminate the Moire fringe with more certainty, the above-described transmittance clearness degree of antiglaring layer 8 is preferably not more than 100%.

With respect to antiglaring layer 8 used in the present invention, from the viewpoint of the above-described elimination of a Moire fringe, the lower limit of the transmittance clearness degree is not particularly limited; however, it is preferably 30% or above in view of the visibility of the liquid crystal display device. Here, it is known in the art that, in order to effectively reduce the transmittance clearness degree of antiglaring layer 8, for example, the period of the surface uneven shape may be increased.

Antiglaring layer 8 used in liquid crystal display device 1 of the present invention can be formed by using an existing method. As the existing method, there are a method of applying a resin solution having a filler dispersed therein on a base material sheet and exposing the filler on the film surface by adjustment of the applied film thickness to form random unevenness on the sheet, a method of curing an ionizing radiation curing resin in a state in which the ionizing radiation curing resin is sandwiched between an emboss mold and a transparent resin film without allowing a filler to be contained, as disclosed in Japanese Patent Laying-Open No. 2002-189106 (Patent Document 4), and the like.

Here, antiglaring layer 8 may be formed directly on the polarizing film of polarizing plate 6, or may be formed by using a transparent resin film having an antiglaring layer attached thereto as the protective film of the polarizing film after the antiglaring layer is formed on the transparent resin film. In this case, the transparent resin film to be used is not particularly limited as long as it is a film having substantial optical transparency, and a specific example thereof is a film made of a cellulose-series resin such as triacetylcellulose, diacetylcellulose, or cellulose acetate propionate, a cycloolefin-series resin, polycarbonate, polymethyl methacrylate, polysulfone, polyether sulfone, polyvinyl chloride, polyethylene terephthalate, or the like. The cycloolefin-series resin is a resin having a cyclic olefin such as norbornene or dimethanooctahydronaphthalene as a monomer, and specific commercially available products thereof include Arton (manufactured by JSR Co., Ltd.), Zeonor (manufactured by Nippon Zeon Co., Ltd.), and Zeonex (manufactured by Nippon Zeon Co., Ltd.).

As the resin that disperses a filler and the resin in the case of transcribing the shape, an ionizing radiation curing type resin is widely used. As such an ionizing radiation curing type resin, a compound having one or more acryloyloxy groups in a molecule is preferably used. In order to improve the mechanical strength of antiglaring layer 8, a trifunctional or more-functional acrylate, namely, a compound having three or more acryloyloxy groups in a molecule is more preferably used. Specific examples thereof include trimethylolpropane triacrylate, trimethylolethane triacrylate, glycerine triacrylate, pentaerythrytol triacrylate, pentaerythrytol tetraacrylate, dipentaerythrytol hexaacrylate, and the like.

Also, in order to impart flexibility to the antiglaring surface to make it less liable to be split, an acrylate compound having a urethane bond in a molecule is also preferably used. A specific example thereof is an urethane acrylate having a structure such that two molecules of a compound having at least one hydroxy group together with an acryloyloxy group in a molecule such as trimethylolpropane diacrylate or pentaerythrytol triacrylate are added to a diisocyanate compound such as hexamethylene diisocyanate or tolylene diisocyanate.

Besides these, other acrylic resins such as ether acrylate series and ester acrylate series that start radical polymerization by ionizing radiation to be cured can also be used. In the case of curing an acrylic ionizing radiation curing type resin by radiation of ultraviolet rays, an ultraviolet radical initiator is added for use in order to generate a radical upon receipt of ultraviolet rays and to start the polymerization and curing reaction.

As the ultraviolet ray radical initiator that starts radical reaction by ultraviolet ray radiation, 1-hydroxycyclohexylphenylketone, 2-methyl-1-[4-(methylthio)phenyl]-2-morpholinopropane- 1-one, and 2-hydroxy-2-methyl-1-phenylpropane-1-one, and besides these, particularly in the case of curing the ultraviolet ray curing type resin by radiation of ultraviolet rays through a transparent resin film containing an ultraviolet ray absorber, a phosphorus-series optical radical initiator having absorption in the visible light region such as bis(2,4,6-trimethylbenzoyl)phenylphosphine oxide, bis(2,6-dimethoxybenzoyl)-2,4,4-trimethylpentylphosphine oxide, or 2,4,6-trimethylbenzoyldiphenylphosphine oxide are suitably used.

Also, a cation polymerizing ionizing radiation curing type resin such as epoxy series and oxetane-series can also be used as the resin to which unevenness is imparted after being cured. In this case, for example, a mixture of a cation polymerizing polyfunctional oxetane compound such as 1,4-bis[(3-ethyl-3-oxetanylmethoxy)methyl]benzene or bis(3-ethyl-3-oxetanylmethyl)ether and an optical cation initiator such as (4-methylphenyl)[4-(2-methylpropyl)phenyl]iodonium hexafluorophosphate is used.

The fine particles to be dispersed in the resin can be suitably selected in accordance with the design of antiglaring layer 8. Examples of such fine particles include porous silica fine particles (refractive index: 1.46), melamine beads (refractive index: 1.57), polymethyl methacrylate beads (refractive index: 1.49), methyl methacrylate/styrene copolymer resin beads (refractive index: 1.50 to 1.59), polycarbonate beads (refractive index: 1.55), polyethylene beads (refractive index: 1.53), polystyrene beads (refractive index: 1.6), polyvinyl chloride beads (refractive index: 1.46), silicone resin beads (refractive index: 1.46), and others.

### EXAMPLES

Hereafter, the present invention will be described in more detail with reference to Examples and Comparative Examples. However, the present invention is not limited to these Examples. In the examples, the terms “%” and “part(s)” representing the content or the amount of use are meant in a weight basis unless specifically mentioned otherwise.

### Example 1

### (1) Fabrication of Mold for Embossing

A product was prepared by performing copper ballad plating on a surface of an iron roll (STKM13A according to JIS) having a diameter of 200 mm. The copper ballad plating is made of copper plating layer/thin silver plating layer/surface copper plating layer, and the combined thickness of the total plating layers was about 200 μm. The copper plating surface was subjected to mirror polishing, and zirconia beads TZ-B53 (manufactured by Toso Co., Ltd., average particle diameter: 53 μm) were blasted on the polished surface with use of a blasting apparatus (manufactured by Fuji Seisakusho Co., Ltd.) under the conditions of a beads use amount being 8 g/cm² (per surface area of the roll), a blasting pressure being 0.15 MPa (gauge pressure), and a distance between the nozzle for jetting the fine particles and the metal surface being 450 mm, so as to form unevenness on the surface. Etching with an aqueous solution of cupric chloride was performed on the obtained iron roll plated with copper having unevenness. The etching amount at that time was set to be 6 μm. Thereafter, chromium plating treatment was carried out to fabricate a mold for embossing. At this time, the chromium plating thickness was set to be 4 μm. The obtained mold had a surface Vickers hardness of 1000.

### (2) Preparation of Antiglaring Film

An ultraviolet ray curing resin composition was obtained in which the following components are dissolved into ethyl acetate at a solid component concentration of 60% and which shows a refractive index of 1.53 after curing.

Pentaerythrytol triacrylate 60 parts

Polyfunctional urethanized acrylate 40 parts

Leveling agent present

Here, as the polyfunctional urethanized acrylate, a reaction product of hexamethylene diisocyanate and pentaerythrytol triacrylate is used.

The ultraviolet ray curing resin composition was applied on a triacetylcellulose (TAC) film having a thickness of 80 μm so that the applied film thickness after drying would be 10 μm, and the resultant was dried for three minutes in a drier set to be 60° C. The dried film was pressed onto the uneven surface of the mold fabricated in the above (1) using a rubber roll so that the ultraviolet ray curing resin composition layer would be on the mold side. In this state, light from a high-pressure mercury lamp having an intensity of 20 mW/cm² was radiated from the TAC film side so as to achieve an h-ray-converted light quantity of 20 mJ/cm², so as to cure the ultraviolet ray curing resin composition layer. Thereafter, the TAC film was peeled off together with the cured resin from the mold, so as to obtain a transparent antiglaring film made of a laminate of the cured resin having unevenness on the surface and the TAC film.

### (3) Fabrication of Liquid Crystal Display Device

Polarizing plates on both of the front and back surfaces were peeled off from a liquid crystal cell of a commercially available liquid crystal television set LC-37GS10 (manufactured by SHARP Co., Ltd.) in which an optical diffusion layer is disposed between the light source and the liquid crystal panel, and a lenticular lens sheet is disposed on the light exiting side (liquid crystal panel side) surface of the optical diffusion layer. In place of those original polarizing plates, polarizing plates SUMIKARAN SRDB31E (manufactured by Sumitomo Chemical Co., Ltd.) were bonded to both the back surface side and the display surface side via a pressure sensitive adhesive so that the respective absorption axes would coincide with the absorption axes of the original polarizing plates. Further, the antiglaring film fabricated in the above (2) was bonded via a pressure sensitive adhesive onto the display surface side polarizing plate so that the side having a random fine uneven shape would be the front surface side, thereby to form an antiglaring layer. The liquid crystal panel obtained in this manner was assembled so as to attain the order of light source/optical diffusion layer (original diffusion sheet of liquid crystal television set LC-37GS10)/liquid crystal panel, so as to fabricate a sample of a liquid crystal display device.

### Example 2

A sample of a liquid crystal display device was fabricated in the same manner as in Example 1 except that an antiglaring film AG3 used as an antiglaring layer in the polarizing plate SUMIKARAN (manufactured by Sumitomo Chemical Co., Ltd.) was used as the antiglaring layer.

### Example 3

A sample of a liquid crystal display device was fabricated in the same manner as in Example 1 except that an antiglaring film AG5 used as an antiglaring layer in the polarizing plate SUMIKARAN (manufactured by Sumitomo Chemical Co., Ltd.) was used as the antiglaring layer.

### Example 4

A sample of a liquid crystal display device was fabricated in the same manner as in Example 1 except that an antiglaring film AG6 used as an antiglaring layer in the polarizing plate SUMIKARAN (manufactured by Sumitomo Chemical Co., Ltd.) was used as the antiglaring layer.

### Comparative Example 1

A mold for embossing having unevenness on the surface was fabricated in the same manner as in Example 1 except that the etching amount at the time of fabricating the mold was changed to 8 μm. The obtained mold had a surface Vickers hardness of 1000. With use of this mold, a transparent antiglaring film made of a laminate of a cured resin having unevenness on the surface and a TAC film was fabricated in the same manner as in Example 1. With use of this as an antiglaring layer, a sample of a liquid crystal display device was fabricated in the same manner as in Example 1.

### Comparative Example 2

A sample of a liquid crystal display device was fabricated in the same manner as in Example 1 except that an antiglaring film AG8 used as an antiglaring layer in the polarizing plate SUMIKARAN (manufactured by Sumitomo Chemical Co., Ltd.) was used as the antiglaring layer.

### Comparative Example 3

A sample of a liquid crystal display device was fabricated in the same manner as in Example 1 except that the antiglaring film was not formed on the uppermost surface of the visible side.

<Evaluation Test 1: Transmittance Clearness Degree>With regard to the antiglaring layers (antiglaring films) used in Examples 1 to 4 and Comparative Examples 1 and 2, the transmittance clearness degree (%) of the antiglaring films was measured with use of a mapping property measurement apparatus ICM-1DP (manufactured by Suga Test Machine Co., Ltd.) according to JIS K 7105. In order to prevent warpage of the samples, they were bonded onto a glass substrate with use of an optically transparent pressure sensitive adhesive so that the uneven surface would be the front surface, and thereafter were subjected to the measurement. In this state, light was allowed to be incident from the glass substrate side, so as to perform the measurement. As described above, the measured value here refers to a sum of the values as measured with use of four kinds of optical combs in which the width between dark parts and bright parts is 0.125 mm, 0.5 mm, 1.0 mm, and 2.0 mm, respectively. Here, in Comparative Example 3, evaluation was made in the same manner in a state in which only the TAC film was bonded to glass with a pressure sensitive adhesive. <Evaluation Test 2: Brightness at the Time of White Display>

Operation of the samples of the liquid crystal display devices obtained in Examples 1 to 4 and Comparative Examples 1 to 3 were started in a dark room. With use of a brightness meter BM5A (manufactured by Topcon Co., Ltd.) the brightness (cd/m²) in the white displaying state was measured.

### <Evaluation Test 3: Moire Fringe>

Operation of the samples of the liquid crystal display devices obtained in Examples 1 to 4 and Comparative Examples 1 to 3 were started in a dark room. The degree of generation of a Moire fringe was evaluated by eye inspection. The degree of intensity (strong or weak) of the Moire fringe was evaluated as follows in five stages from 1 to 5.

Moire fringe

1: Moire fringes are not observed

2: Intermediate level between 1 and 3

3: Moire fringes are observed

4: Intermediate level between 3 and 5

5: Moire fringes are clearly observed

The results of evaluation tests 1 to 3 are shown in Table 1.

TABLE 1

| | Transmittance | Brightness at the | |
|---|---|---|---|
| | clearness | time of white | Moire |
| | degree (%) | display (cd/m²) | fringe |
| Example 1 | 107.3 | 316 | 2 |
| Example 2 | 97.1 | 315 | 2 |
| Example 3 | 65.9 | 318 | 1 |
| Example 4 | 40.9 | 313 | 1 |
| Comparative Example 1 | 160.9 | 316 | 3 |
| Comparative Example 2 | 199.8 | 313 | 4 |
| Comparative Example 3 | 390.1 | 320 | 5 |

Here, in Table 1, the contents of the transmittance clearness degree of Example 1, for example, are as follows.

### Transmittance clearness degree

0.125 mm optical comb: 26.0%

0.5 mm optical comb: 22.8%

1.0 mm optical comb: 23.5%

2.0 mm optical comb: 35.0%

Sum: 107.3%

As shown in Table 1, it has been found out that the liquid crystal display devices of Examples 1 to 4 had a high brightness and showed a good visibility without the generation of a Moire fringe. Further, in the liquid crystal display devices of Examples 3 and 4 in which the transmittance clearness degree is particularly low, almost no Moire fringe was observed. On the other hand, in the liquid crystal display devices of Comparative Examples 1 to 3 in which the transmittance clearness degree exceeded 150%, a Moire fringe was observed though exhibiting a high brightness, resulting in considerable deterioration of the visibility. Also, from the results shown in Table 1, it will be understood that the degree of the Moire fringe increases as the transmittance clearness degree rises.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A liquid crystal display device comprising, in this order:
a light source;
an optical diffusion layer; and
a liquid crystal panel having polarizing plates disposed on both surfaces of a liquid crystal cell, wherein
a surface of the optical diffusion layer on a liquid crystal panel side has a periodic fine shape, and an uppermost surface of the polarizing plate disposed on a visible side of the liquid crystal panel has an antiglaring layer having a random fine uneven shape and having a transmittance clearness degree of not more than 150%.

2. The liquid crystal display device according to claim 1, wherein the transmittance clearness degree of the antiglaring layer is not more than 100%.

3. The liquid crystal display device according to claim 1, wherein the periodic fine shape on the surface of the optical diffusion layer is constructed with a lens sheet in which a plurality of unit lenses are arranged on a liquid crystal panel side thereof

4. The liquid crystal display device according to claim 3, wherein the lens sheet is a lenticular sheet having a lens part in which a plurality of semi-cylindrical convex cylindrical lenses are arranged in parallel in one direction.
